(19) United States
(12) Patent Application Publication
(10) Pub. No.: US 2014/0095976 A1
(43) Pub. Date: Apr. 3, 2014

(54) Social Context for Content from Systems External to a Social Networking System

(71) Applicants: Mitu Singh, San Carlos, CA (US); Siddharth Kar, Palo Alto, CA (US); Cameron Alexander Marlow, Menlo Park, CA (US)

(72) Inventors: Mitu Singh, San Carlos, CA (US); Siddharth Kar, Palo Alto, CA (US); Cameron Alexander Marlow, Menlo Park, CA (US)

(21) Appl. No.: 13/633,110

(22) Filed: Oct. 1, 2012

(51) Int. Cl. G06F 17/22

(52) U.S. Cl. CPC G06F 17/2247
USPC 715/234

(57) ABSTRACT

A social networking system provides an instruction that a third-party system may include in a web page or other content. The instruction includes information identifying content presented by the web page or other content specified by the third-party system. The information identifying the content presented by the web page is communicated to the social networking system. Based on the information identifying the content, the social networking system determines a social context for a viewer of the web page. The social context may be selected to optimize for a particular conversion event.

### BACKGROUND

This invention relates generally to social networking systems and, more specifically, to providing a social context for content external to a social networking system.

Social networking systems maintain information about users in a social graph, which may include edges and nodes representing interactions and connections between objects in the social networking system. Hence, the social networking system builds and maintains relationships between objects, such as users. For example, users can connect to one another, identify preferences for brands or products, create events or perform other actions.

Social networking systems also provide many services to enhance interactions by its users. For example, a social networking system provides a user with updates relevant to the user and to interests and activities of the user's friends and connections. For content provided to a user from within the social networking system (onsite content), the social networking system may provide additional information related to the provided content. This related information is the “social context” for the content provided to the user and may describe actions by other users of the social networking system involving the content provided to the user. For example, social context for provided content may describe other users who have interacted with the provided content, types of interactions between other users with the provided content, updates to the provided content, and other activities related to the provided content. When the provided content is from the social networking system, an object maintained by the social networking system and associated with the provided content is frequently used to identify the social context for a user.

However, users may interact with the social networking system while browsing content on third-party systems that are external to the social networking system. Although content from the third-party systems is external to the social networking system, users may have interacted with similar content within the social networking system. However, conventional social networking systems are unable to identify content within the social networking system associated with the content external to the social networking system, preventing conventional social networking systems from providing social context for content external to the social networking system.

### SUMMARY

To allow third-party systems to leverage social information maintained in a social networking system, embodiments of the invention enable a third-party system to incorporate a social context for content presented by the third-party system to a user accessing the third-party content. Based on information from the third-party system describing the content external to the social networking system, an object maintained by the social networking system is determined and used to identify the social context for the content external to the social networking system. In some embodiments, the social context from the social networking system is presented in a frame or window of a web page from the third-party system including the external content when the web page is rendered and displayed on a user device.

In one embodiment, a user device requests content, such as a web page, from a third-party system that is separate from a social networking system. For example, the third-party system sends a markup language document for the requested web page to the user device. The markup language document includes an instruction for the user device to incorporate within the web page information obtained from the social networking system. Additionally, the markup language document includes information from the third-party system describing the content from the third-party system. For example, the markup language document includes keywords, terms, categories, social networking system object identifiers or other data describing the content in the markup language document sent to the user device. In one embodiment, the instruction creates a frame within the web page that includes social context obtained directly from the social networking system (e.g., an iframe).

Based on the instruction and description of the content from the third-party system in the received markup language document, the user device requests personalized content from the social networking system. Using the description of the content from the third-party system, the social networking system identifies an object in the social networking system and determines the social context for the content from the third-party system using the identified object. For example, the social networking system identifies an object associated with a threshold number of keywords matching keywords in the description of the content from the third-party system. As another example, the social networking system identifies one or more objects having object identifiers associated with the description of the content from the third-party system. Interactions between social networking system users and the identified object are used to determine the social context for the content from the third-party system that is communicated to the user device for presentation.

In some embodiments, the social networking system uses conversion events associated with the third-party system when determining social context for content from the third-party system. Conversion events may be specified by the third-party system and include specified types of interactions between users and content from the third-party system. Examples of conversion events include placing an order for a product from the third-party system, providing a comment to the third-party system, uploading content to the third-party website or other suitable actions. The third-party system may identify conversion events to the social networking system, which stores data associating a social context associated with content prior to occurrence of the conversion event. Using the stored associations between conversion events and social contexts, the social networking system may select a social context to increase the likelihood of a user performing a specified conversion event after being presented the social context.

### BRIEF DESCRIPTION OF THE DRAWINGS

FIG. 1 is a block diagram of a system environment including a social networking system, in accordance with one embodiment.

FIG. 2 is an example social graph maintained by a social networking system, in accordance with one embodiment.

FIG. 3 is an interaction diagram of a method for selecting a social context for content external to a social networking system, in accordance with one embodiment.

FIG. 4 is a flow chart of a method for providing a social context for content external to a social networking system, in accordance with one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

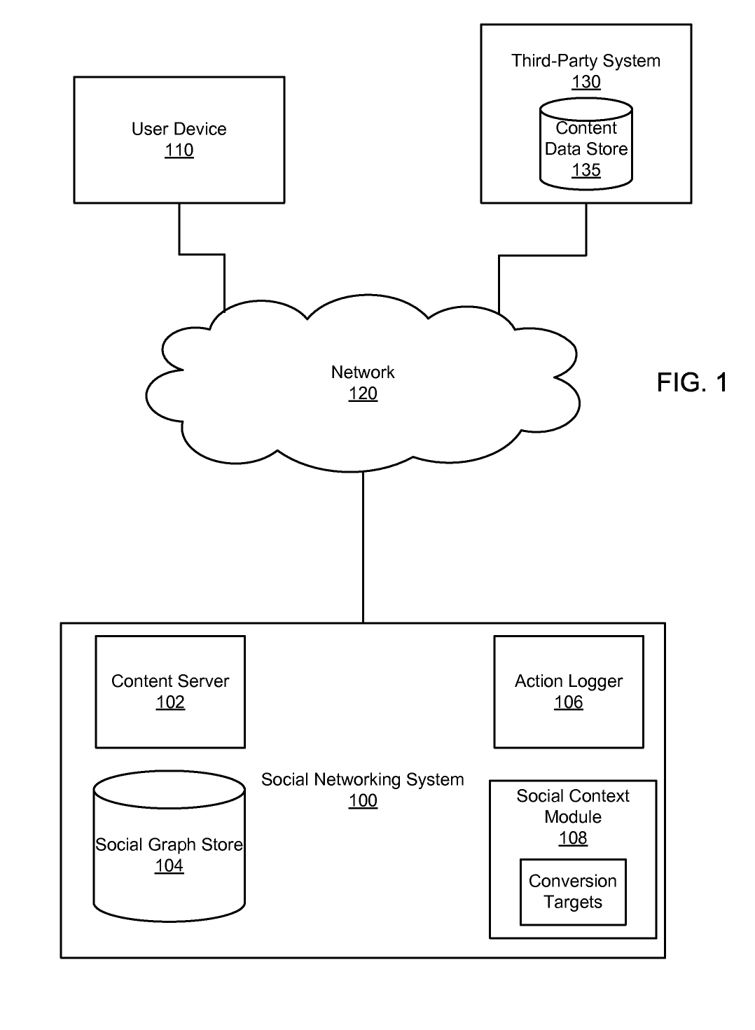

FIG. 1 is a block diagram of a system environment including a social networking system 100. The social networking system communicates 100 with a user device 110 and a third-party system 130 through a network 120. The user device 110 receives content from the social networking system 100 and/or from the third-party system 130. For example, the user device 110 receives web pages from the third-party system 130 that include content maintained by the third-party system 130. To provide social context for content from the third-party system 130, the social networking system 100 may receive information from the user device 110 describing the content provided to the user device 110 from the third-party system 130. Based on the description from the third-party system 130, the social networking system 100 determines a social context and provides information associated with the content from the third-party system 130 to the user device 110. In one embodiment, the third-party system 130 communicates the description of the content to the social networking system 100 rather than the user device 110.

The user device 110 may comprise any computing device capable of processing data as well as transmitting and/or receiving data via the network 120. Examples of the user device 110 include: a desktop computer, a laptop, a tablet, a mobile phone, a set-top box, a gaming console, a hand-held computing device, or any other computing device capable of accessing content on the network 120. The user device 110 receives content from the third-party system 130 and/or from the social networking system 106 and to render the received content for presentation to a user. Additionally, the user device 110 may execute instructions provided by the third-party system 130. For example, the user device 110 executes an instruction received from the third-party system 130 to retrieve information from the social networking system 100 for presentation in conjunction with the content from the third-party system 130. Retrieval of content from the social networking system 100 for presentation along with content from the third-party system 130 is further described in U.S. Pat. No. 8,250,145, which is hereby incorporated by reference herein in its entirety. For example, the third-party system 130 communicates with the user device 110 via a hypertext markup language (HTML) protocol and the user device 110 executes an HTML, or other scripting, instruction to retrieve information from the social networking system 100.

The network 120 may include wireless networks, wired networks, or a combination of network types, and provides a channel for communications between the user device 110, the social networking system 100 and/or the third-party system 130. Communications between the various components may be exchanged using any suitable protocol or combination of protocols.

The third-party system 130 comprises one or more web servers providing content to the user device 110 via the network 120. The third-party system 130 is separate from the social networking system 100. For example, the third-party system 130 is associated with a first domain while the social networking system 100 is associated with a separate social networking domain. The third-party system 130 may provide content to the user device using web pages that comprise markup language documents identifying content and including instructions specifying formatting or presentation of the identified content. In one embodiment, a web page from the third-party system 130 includes instructions that, when executed by the user device 110, retrieve data from the social networking system 100 and display the information retrieved from the social networking system 100. For example, an instruction associated with the social networking system 100 generates a frame within the web page that includes information from the social networking system 100. Hence, the instruction allows content from the third party system 130 to provide personalized content using information from the social networking website 100 when the web page is rendered and displayed by the a user device 110. The markup language document may also include a description of content presented by the web page from the third-party system 130, such as keywords, terms, categories or other content descriptions as further described below.

The instructions may be provided in a portion of the web page, for example an iframe, that instructs the user device to communicate with the social networking system 100.

The user's

In one embodiment, the social networking system 100 includes a content server 102, a social graph store 104, an action logger 106, and a social context module 108. The social graph store 104 stores user profiles describing characteristics of social networking system users and other objects maintained by the social networking system 100. Examples of objects included in the social graph store 104 include applications, events, groups, pages associated with businesses, organizations or other entities or other suitable data. The social graph store 104 also stores connections between social networking system users and other users and/or objects included in the social graph store 104. The content server 102 selects content provided to users by the social networking system (“social networking content”) based on data in the social graph store 104. Content selected by the content server 102 is communicated to a user device 110 for presentation to a user. A method of storing social graph information that allows third parties to define actions and objects in the social graph store 104 is described in U.S. Pat. No. 8,250,145, issued Aug. 21, 2012, and is hereby incorporated by reference in its entirety.

To tailor content and other information to a user's interests, the action logger 106 records and stores information about the user's interactions with other users and objects in the social graph store 104. Example user interactions include: a user viewing an object, accessing an object, posting a comment on a photo, posting content to a page and other suitable type of interactions with social networking objects. The user interactions may be used by the social networking system 100 for various purposes. For example, the content server 102 determines a user's affinities for various objects based on the user's interaction with the objects and uses the determined affinities to select content for presentation to the user.

The social context module 108 determines social context associated with content external to the social networking system 100. As used herein, a “social context” is social networking content associated with the content external to the social networking system 100. For example, social context for a web page including a product may include identifiers of social networking system users that expressed a preference for a page in the social networking system 100 associated with the product, comments from social networking system users posted to a page in the social networking system 100 associated with the product or other suitable information maintained by the social networking system 100. Thus, the social context can include any social networking user interaction with the object associated with third party content. Typically, social context is determined based on one or more objects maintained by the social networking system 100 associated with a topic, a keyword, or another characteristic matching, or similar to, one or more characteristics of the content external to the social networking system 100. As further described below, the social networking system 100 receives information describing the content external to the social networking system 100 and identifies an object in the social networking system 100 based on the received information. In one embodiment, the social networking system 100 receives a specific social networking object from the third-party system 130 through the user device 110. The specific networking object may be designated by the third-party system 130 in the page generated for the user device 110 or included by an API in a frame including the reference to the social networking system 100. Based on the identified object maintained by the social networking system 100, social context for the content external to the social networking system 100 is determined.

The social networking system 100 may also determine a generalized social context for objects maintained by the social networking system 100. A generalized social context identifies one or more concepts common to multiple objects. For example, several objects in the social networking system 100 may refer to the same movie, such as a page created for the movie by a movie studio, a review of the movie, and a comment describing the movie. Each of these objects relates to the same concept of the movie, so the movie is the generalized social context for the objects. Social context and uses for a social context are further described in U.S. application Ser. No. 13/295,002, filed Nov. 11, 2011, and Ser. No. 13/043,424, filed Mar. 8, 2011, which are each incorporated by reference in their entirety.

The social context module 108 also receives requests for social context from the user device 110. These requests include information describing external content provided by a third-party system 130. The information describes content external to the social networking system 100 provided by the third-party system 130, and allows the third-party system 130 to provide information to the social networking system 100 for identifying an object associated with the content external to the social networking system 100. By providing information used to identify the object in the social networking system 100, the third-party system 130 has increased control over the social context associated with the content external to the social networking system 100. Examples of information used to identify the object in the social networking system 100 include one or more keywords, one or more terms, a category, one or more terms and a category, one or more identifiers of objects maintained by the social networking system or other suitable information. For example, a user may be viewing a web page for a book provided by a third-party system 130 and the user device 110 transmits a request for social context including information describing the book, such as the title, author, publisher or other suitable information. In one embodiment, the information is provided to the social networking system when the user accesses the web page, in another embodiment, the information may be obtained by the social networking system by crawling web pages. When crawling the webpages, the social networking system may extract keywords and concepts from the web page as information for determining the applicable objects.

Selection of social context associated with content external to the social networking system 100 may also be based on conversion targets associated with the third-party system maintained in the social context module 108 or specified by the information describing the content external to the social networking system 100. A conversion event is a user interaction with content maintained by the third-party system 130 that indicates the user's interest in the content provided by the third-party system 130. A conversion target indicates one or more desired conversion events and/or a frequency of a desired conversion event. Each conversion event may be provided to the social networking system 100 by the third-party system 130 when a conversion event occurs at the third-party system 130. Examples of conversion events include a product retailer selling a product, receiving a user review about a product, or receiving a request for a quote for a product. By providing the conversion event to the social context module 108, the third-party system 130 allows the social context module 108 to determine social contexts provided to the user prior to the conversion event. This allows selection of a social context associated with content external to the social networking system 100 to account for prior effects of social contexts on conversion events.

In one embodiment, the social context module 108 uses a machine learning algorithm trained using conversion events and the social contexts presented prior to each conversion event to identify the effect of social contexts on conversion events. Based in part on the conversion targets, the social context module 108 determines a social context associated with the content external to the social networking system. In one embodiment, third-party systems 130 have an interest in receiving percentages of different conversion events. For example, the third-party system 130 specifies 60% sale events, 15% product review events, and 25% quote inquiry events. As conversion events provide results above or below the desired conversion targets, the social context module 108 associates social contexts with content external to the social networking system 100 to influence subsequent conversion events. For example, to increase the likelihood of a subsequent conversion event being a sale event, the social context module 108 associates a social context with content external to the social networking system 100 that was previously presented prior to a threshold number of percentage of sale events. Based on historical conversion events and social contexts previously associated with the content external to the social networking system, one or more machine learning algorithms used by the social context module 108 may identify a social context likely to increase the likelihood of a particular type of conversion event if presented with the context external to the social networking system 100.

The third-party system 130 provides content to the user device 110 and may be any system external to the social networking system 100. The third-party system 130 provides the user device 110 with a markup language document including formatting information for displaying content maintained by the third-party system 130. The markup language document includes one or more instructions that, when executed by an application of the user device 110, transmit a request for data to the social networking system 100 and display the information retrieved from the social networking system 100. The request for data includes information describing the content included in the markup language. For example the request for data includes keywords or terms associated with the content included in the markup language document, a category associated with the content included in the markup language document, one or more object identifiers associated with objects maintained by the social networking system 100, any combination of the preceding or any other suitable information. The one or more instructions included in the markup language may generate a frame within a web page generated by the markup language document, where the frame includes information from the social networking system 100 selected based on the information describing the content included in the markup language document. Hence, a web page from the third party website may provide social context from the social networking system 100 associated with content from the third-party system 130 presented when the web page is rendered and displayed by the user device 110.

The third-party system 130 also includes a content data store 135 maintaining information, such as metadata, associated with content provided by the third-party system 130. For example, a third-party system 130 provides content relating to various products, and the content data store 135 maintains metadata describing each product, such as the product's name, publisher, distributor, and other product-specific information. For a book, metadata included in the content store 135 may include the book's author, publisher, genre, series, or other suitable information. In one embodiment, the third-party system 130 selects information from the content store 135 associated with content provided to the user device and includes the information from the content store in the instruction to request data from the social networking system 100 associated with the content external to the social networking system 100. Hence, the markup language document sent from the third-party system 130 to the user device 110 includes data describing the content from the third-party system 130 from the content store 135.

### Social Graph

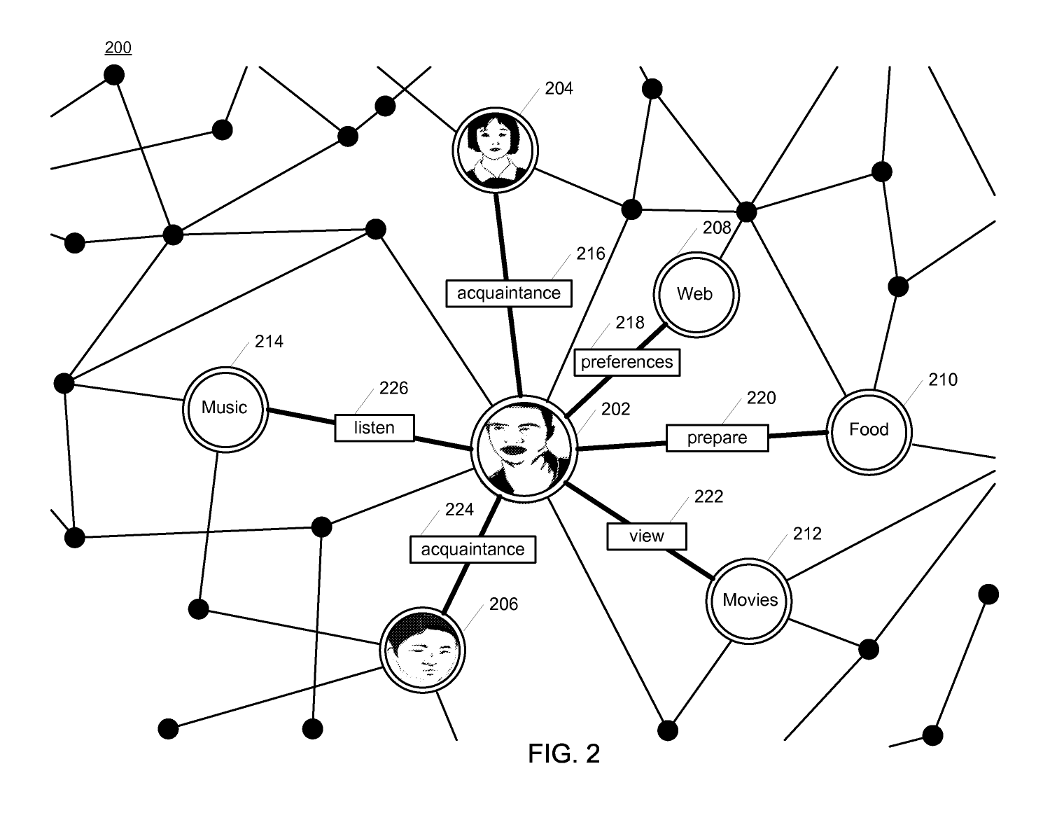

FIG. 2 illustrates an example social graph 200 including multiple nodes 202, 204, 206, 208, 210, 212, and 214, representing a variety of objects maintained by the social networking system that can act on and/or be acted upon by another object. In FIG. 2, the nodes 202, 204, and 206 represent user objects. The node 208 represents a page object associated with an external website, while the node 210 represents a recipe object from a cooking application. Also, the node 212 represents a video object (e.g., a movie) from a video streaming application, and the node 214 represents a song object from a music streaming application.

An edge between nodes in the social graph 200 represents a connection between the objects corresponding to the nodes, which may have a particular connection type. For example, an edge 216 between the node 202 and the node 204 has a connection type of “acquaintance” to show the relationship between the users corresponding to the node 202 and the node 204; similarly, an edge 216 between the node 202 and the node 206 also has an “acquaintance” type to show a relationship between users corresponding to the node 202 and the node 206. In another example, an edge 218 having a “preference” connection type connects the node 202 with the node 208 to illustrate that the user corresponding to the node 202 “likes” or prefers the page object corresponding to the node 208.

Connections, represented by edges, may be created from an action performed by an object on another object. For example, the user represented by the node 202 performs an action having a type of “prepare” to the recipe object corresponding to the node 210, so an edge 220 having a “prepare” connection type is created between the node 202 and the node 210. Similarly, the user represented by the node 202 performs an action of “listen” to the song associated with node 214, causing an edge 226 with a connection type of “listen” to be crated between the node 202 and the node 214. In FIG. 2, the user corresponding to the node 202 also performs a “view” action on the movie corresponding to the node 212, so an edge 222 with a “view” connection type is created between the node 202 and the node 212. Examples of other actions include listing objects in a user profile, subscribing to or joining a group or fan page, sending a message to another social networking system user, making a purchase associated with an object, commenting on a content item, or responding to an invitation to an event. Hence, the social graph 200 allows the social networking system 100 to represent objects in the social networking system 100 as well as relationships or associations between the objects.

### Selecting Social Context for Content External to the Social Networking System

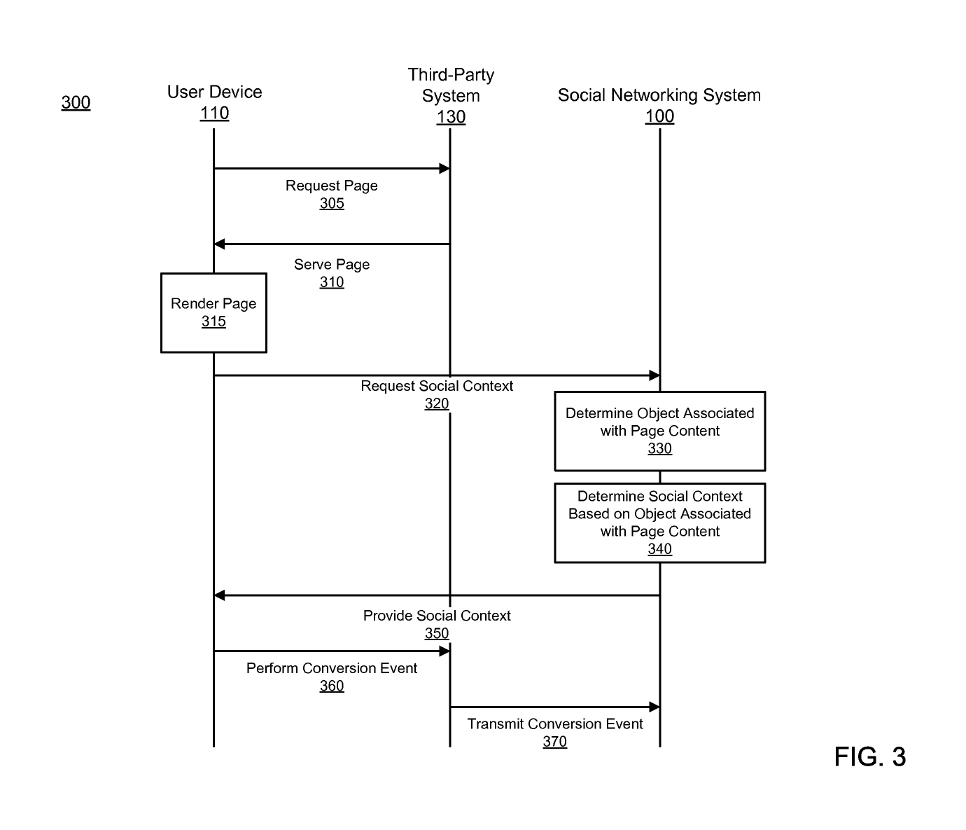

FIG. 3 is an interaction diagram of one embodiment of a method 300 for selecting a social context associated with content external to a social networking system 100. Initially, a user device 110 requests 305 a web page from the third-party system 130. For example, a user of the user device 110 enters a uniform resource locator (URL) or other identifier associated with the web page into a browser application operating on the user device. The browser application identifies the third-party system 130 associated with the received URL or other identifier and requests 305 a web page associated with the received URL or other identifier from the identified third-party system 130. In one embodiment, the browser application is a specialized browser for browsing particular content, such as a customized mobile device application.

After receiving the request for the web page, the third-party system 130 generates the requested web page using locally-stored data. For example, the third-party system 130 generates a markup language document describing the content and formatting of the web page based on stored data. The third-party system 130 includes one or more instructions in the web page that, when executed by an application of the user device 110, retrieve data from the social networking system 100 and display the information retrieved from the social networking system 100. The web page also includes information from the third-party system 130 describing the content included in the web page. For example, the third-party system 130 retrieves a content description, such as keywords, terms, categories, object identifiers or other information from the content data store 135 and includes the content description in the web page. This allows the third-party system 130 to describe the content of the web page or to identify objects in the social networking system 100 associated with the content of the web page. In one embodiment, the instructions included in the web page are one or more instructions that, when executed by the user device 110, retrieve information from the social networking system 100 and generate a frame within the web page including the retrieved information. For example, the one or more instructions generate iframe within the web page 122. The one or more instructions in the web page include a uniform resource locator (URL), or other web page identifier, associated with the social networking system 100 and may also include one or more parameters describing presentation of the frame, or iframe, by the user device 110.

For example, the instruction included in the web page specifies <ifame src=“http://www.socialnetwork.com/widgets/recommendations.php?header=false&amp; height=300&amp;width=500&amp;site=externalwebsite.com scrolling=“no” frameborder=“0” style=“border: medium none; overflow: hidden; height: 300px; width: 500px;”></iframe>, which generates an iframe including data from the URL www.socialnetwork.com/widgets/recommendations.php and identifier parameters such as height, width and border style of the iframe. The one or more instructions include the information describing the content presented by the web page or retrieve the information describing the content presented by the web page from the web page, so the information describing the content presented by the web page may be communicated to the social networking system 100 for identifying a social context associated with the content presented by the web page.

The third-party system 130 then serves 310 the markup language document describing the generated web page and including the one or more instructions to retrieve information from the social networking system 100 to the user device 110 through the network 120. After receiving the markup language document, the user device 110 renders 315 the web page based on the content and formatting instructions included in the markup language document. In addition to rendering 315 the web page, the user device 110 executes the one or more instructions to present content from the social networking system 100 with the web page content. For example, executing the one or more instructions creates a frame in the web page. Execution of the one or more instructions also causes the user device 110 to request 320 social context associated with the content of the web page from the social networking system 100 via the network 120. The information describing the web page content is retrieved from the web page and transmitted to the social networking system 100 when social context is requested, allowing the third-party system 120 to influence determination of the social context.

In one embodiment, the social networking system 100 also checks the user device 110 for a cookie in response to receiving the request for social context from the user device 110. Responsive to the social networking system 100 checking for the cookie, the user device 110 sends the cookie, or a message associated with the cookie, to the social networking system 100. In one embodiment, the existence of the cookie indicates whether the user of the user device 110 is a user of the social networking system 100 (e.g., whether the user has a valid account with the social networking system 100). If the user of the user device 110 is a user of the social networking system 100, the cookie may contain information indicating whether the user is logged into the social networking system 100 (e.g., whether the user has a current valid session with the social networking system 100). Checking the user device 110 for a cookie allows the social networking system 100 to authenticate the user session. In other embodiments, the social networking system 100 may determine whether the user is a user of the social networking system 130 (e.g., by checking for an existence of a cookie, without determining whether the user is logged into the social networking system 100). Although cookies are described herein for authenticating the user and/or the user session, any other methods of user or session identification or authentication may be used (such as recognizing a physical token).

If the user associated with the received cookie has been authenticated, the social networking system 100 determines 330 one or more objects in the social networking system 100 associated with the web page content. For example, the social networking system 100 identifies objects associated with keywords matching, or associated with, keywords or terms included in the request for social context. As the keywords or terms in the request for social context are provided by the third-party system 130, determination of the object is based in part on the information provided by the third-party system 130. As another example, the social networking system 100 identifies one or more objects having object identifiers included in the request for social context, allowing the third-party system 130 to specify the objects associated with the web page content.

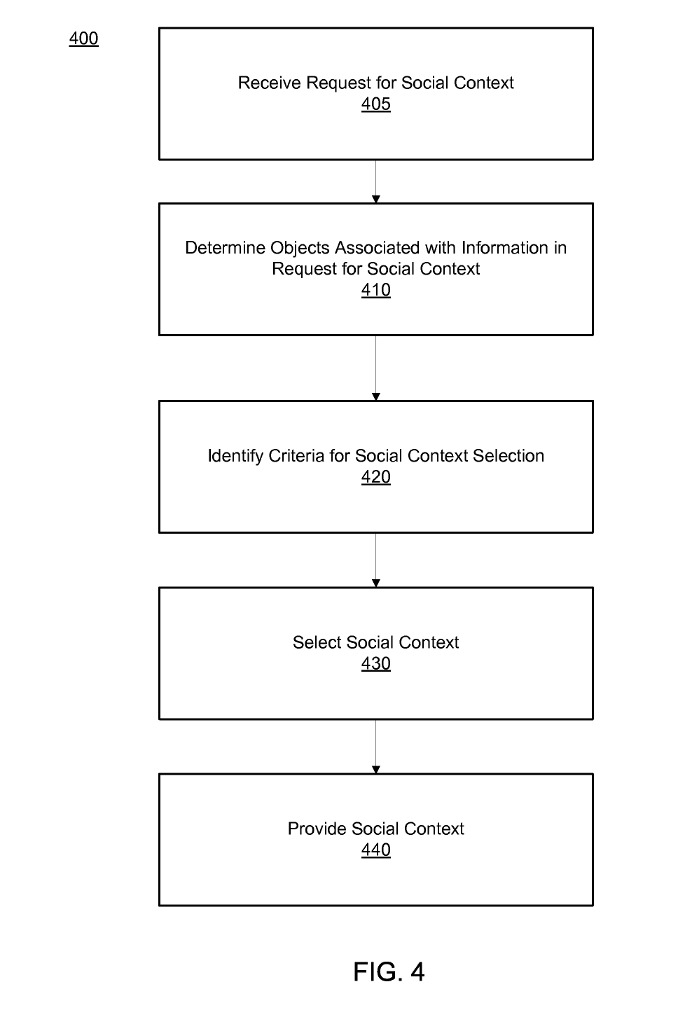

Based on the objects or objects associated with the web page content, the social networking system 100 determines 340 a social context associated with the web page content. The social context describes actions performed by one or more social networking system 100 involving the object or objects associated with the web page content. Examples of social context include identifiers of social networking system users that expressed a preference for a page in the social networking system 100 associated with the web page content, comments from social networking system users posted to a page in the social networking system 100 associated with the web page content or other suitable information maintained by the social networking system 100. As further described below in conjunction with FIG. 4, various criteria may be used to determine 340 the social context associated with the web page content, allowing different social contexts to be associated with the web page content at different times. The social networking system provides 350 the determined social context to the user device 110 via the network 120, and the user device 110 presents the social context in conjunction with the web page content. For example, the social context is displayed in a frame within the web page.

In one embodiment, the user of the user device 110 performs 360 a conversion event while interacting with the web page. For example, the user purchases a product shown via the web page or provides a review for a product shown via the web page. The user device 110 communicates the conversion event to the third-party system 130, which may transmit 370 the conversion event to the social networking system 100 as well as a description of the social context provided 350 to the user device prior to performance of the conversion event. This allows the social networking system 100 to associate conversion events with the social context that was provided to the user device 110, enabling conversion events to be used when determining 340 social context for the web page content. For example, associations between conversion events and social context may be used to train a computer model to determine a social context that increases various types of conversion events.

### Identifying Social Context

FIG. 4 is a flow chart illustrating an embodiment of a method 400 of providing a social context for context external to a social networking system 100. The social networking system 100 receives 405 a request for social context from a user device 110, such as a request to provide a social context for a book. The request includes information describing content external to the social networking system 100, such as content included in a web page provided by a third-party system 120. Examples of information describing content external to the social networking system 100 include keywords, terms, categories, object identifiers or other information describing the content external to the social networking system 100. Using the book example, the information may include the book's title, author, publisher, genre, and intended reading audience. In one embodiment, the information describing the content external to the social networking system 100 is provided by the third-party system 120 maintaining the content external to the social networking system. The request may also include a user identifier specifying the social networking system user accessing the content external to the social networking system 100. The user identifier may be based on an identifier maintained on the user device 110, such as a cookie or other token. Since the request is typically made by the user device 110 to the social networking system 100, such as through an iframe in the user's browser, the user's information is not exposed to the third party system.

Based on the information describing content external to the social networking system 100, the social networking system 100 determines 410 objects in the social networking system 100 associated with the content external to the social networking system 100. For example, the social networking system 100 identifies objects associated with at least a threshold number of keywords matching keywords or terms in the information describing the content external to the social networking system 100. As another example, the social networking system 100 retrieves objects associated with object identifiers specified by the information describing the content external to the social networking system 100. For the book example, the social networking system may identify a social networking object for the title, an object for the author, and an author for the publisher. Social networking objects that are related to but do not exactly match the information may also be selected. For example, other books related to the book described by the social information may be selected for consideration.

After determining 410 objects associated with the content external to the social networking system 100, the social networking system 100 identifies 420 one or more criteria for selecting social context. For example, the social networking system 100 accesses computer models to determine whether the third-party system 130 is associated with computer models for selecting social context based on conversion events. Alternatively, the social networking system determines whether the third-party system 130 is associated with criteria for selecting a particular type of social context. For the book example, the third party system 130 may select book purchases and book reviews as high value conversion events for the computer models to optimize. Based on the determined objects and any identified criteria, the social networking system 100 selects 430 a social context associated with the content external to the social networking system 100.

For example, the social networking system 100 applies a computer model to information associated with the determined objects as well as a user profile associated with the user accessing the content external to the social networking system to select a social context to increase the likelihood of the user performing a specified conversion event or specified type of conversion event. The computer model may be chosen based on a conversion event associated with the third-party system 130 or specified in the request based on the frequency of prior conversion events. The frequency of prior conversion events may be compared to specified conversion targets to select 430 social contexts modifying the likelihood of various types of conversion events occurring.

As another example, one or more criteria are used to select 430 a social context associated with the content external to the social networking system 100. Using the determined objects and the user profile of the user accessing the content external to the social networking system 100, users connected to at least one of the determined objects and to the user accessing the content external to the social networking system 100 are identified. The determined object connected to the highest number of users also connected to the user accessing the content external to the social networking system 100 is identified and one or more actions of users connected to the identified object and to the user accessing the content external to the social networking system are selected 430 as the social context. As another example, an additional object having a threshold number of characteristics in common with a determined object is identified as the social context. The social context request may also specify a characteristic of the content external to the social networking system 100 that is most important to the third-party system 130 and the social networking system 100 selects 430 the social context as another object having a characteristic matching or associated with the specified characteristic. For example, for a book, the third-party system 130 may indicate that the author is the most important aspect is the author; hence, the social context is selected as another object associated with the author. The selected social context is then provided 440 to the user device 110 by the social networking system 100.

The social context may also indicate a reason why a particular social context was selected. For example, a user may be shown a related book's social context because the user's friends like the related book in addition to the book the user is viewing at the third-party system. The selection of a social context may include all social networking connections to the social networking objects, including various custom edges. For example a social networking object representing a book may include a custom edge indicating a user “read” the book, and a third party system 130 may also provide a custom edge indicating a user “reviewed” the book on the third-party system 130.

In one embodiment, if the social networking system 100 is unable to select 430 a social context associated with the content external to the social networking system 100, information describing actions taken by all users of the social networking system on various objects maintained by the social networking system 100 is provided 440 to the user device. The actions taken by all users may also be described when the social networking system is unable to identify the user. Hence, rather than provide 440 social context specific to the content external to the social networking system 100, the social networking system 100 provides generalized context of user actions with various objects maintained by the social networking system 100. Accordingly, if a social context is unable to be identified from the information describing the content external to the social networking system 100, global information based on actions performed on all objects of the social networking system 100, rather than on objects associated with the content external to the social networking system, may be provided 440.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for obtaining social information, the method comprising:
requesting a web page from a third-party system within a domain that is different from a domain of a social networking system;
receiving at a user device a markup language document for the requested web page;
transmitting a request for information from the social networking system for presentation within the requested web page, the request including information describing content of the requested web page;
providing to the social networking system an identification of a user associated with the user device;
receiving the requested information from the social networking system, wherein the received requested information was determined by the social networking system based on the information describing content of the requested web page included in the request;
rendering the web page and content based on the received requested information within the web page; and
displaying the rendered web page.

2. The method of claim 1, wherein the information describing content of the requested web page comprises one or more keywords specified by the third-party system.

3. The method of claim 1, wherein the information describing content of the requested web page comprises one or more object identifiers associated with one or more objects maintained by the social networking system.

4. The method of claim 3, wherein an object identifier identifies a page maintained by the social networking system.

5. The method of claim 1, wherein the information describing content of the requested web page comprises a category associated with the content of the requested web page and one or more keywords associated with the content of the requested web page.

6. The method of claim 1, wherein the requested information from the social networking system comprises an action performed on an object in the social networking system having one or more characteristics matching the information describing content of the requested web page.

7. The method of claim 6, wherein the object in the social networking system has at least a threshold number of characteristics matching the information describing content of the requested web page.

8. The method of claim 6, wherein the object in the social networking system has at least a highest number of connections to other social networking system users connected to the user associated with the user device.

9. The method of claim 1, wherein the requested information from the social networking system comprises a description of an object having a characteristic matching a characteristics specified by the information describing content of the requested web page.

10. The method of claim 1, wherein the received requested information was determined by the social networking system based on the information describing content of the requested web page included in the request and based on one or more prior conversion events associated with the third-party system by the social networking system.

11. A method comprising:
receiving at a social networking system a request for a social context from a third-party system, the request including information describing content of a web page external to the social networking system and maintained by the third-party system;
identifying a user associated with the received request;
accessing information associated with a plurality of objects maintained by the social networking system and describing connections between the objects;
selecting one or more objects associated with the content of the web page external to the social networking system based on the information describing the content of the web page external to the social networking system included in the request;
retrieving a user profile maintained by the social networking system and associated with the identified user;
selecting a social context associated with the content of the web page external to the social networking system based on at least one of characteristics of the selected one or more objects associated with the content of the web page external to the social networking system and characteristics of the user profile; and
providing the social context for presentation as content within the web page external to the social networking system.

12. The method of claim 11, wherein the information describing content of a web page external to the social networking system and maintained by the third-party system comprises one or more keywords specified by the third-party system.

13. The method of claim 11, wherein the information describing content of a web page external to the social networking system and maintained by the third-party system comprises one or more object identifiers of objects maintained by the social networking system.

14. The method of claim 13, wherein an object identifier identifies a page maintained by the social networking system.

15. The method of claim 11, wherein the information describing content of a web page external to the social networking system and maintained by the third-party system comprises a category associated with the content of the requested web page and one or more keywords associated with the content of the web page.

16. The method of claim 11, wherein selecting the social context associated with the content of the web page external to the social networking system based on at least one of characteristics of the selected one or more objects associated with the content of the web page external to the social networking system and characteristics of the user profile comprises:
identifying users of the social networking system connected to each of the one or more objects associated with the content of the web page external to the social networking system and connected to the user profile;
selecting an object associated with the content of the web page external to the social networking system and connected to a highest number of users of the social networking system connected to the user profile; and
determining the social context associated with the content of the web page external to the social networking system based on the selected object.

17. The method of claim 16, wherein determining the social context associated with the content of the web page external to the social networking system based on the selected object comprises:
determining one or more actions performed by the users connected to the selected object and connected to the user profile; and
selecting an action as the social context.

18. The method of claim 11, wherein selecting the social context associated with the content of the web page external to the social networking system based on at least one of characteristics of the selected one or more objects associated with the content of the web page external to the social networking system and characteristics of the user profile comprises:
selecting an object maintained by the social networking system having at least a threshold number of characteristics matching the information describing content of a web page external to the social networking system and maintained by the third-party system; and
determining an action associated with the selected object.

19. The method of claim 11, wherein selecting the social context associated with the content of the web page external to the social networking system based on at least one of characteristics of the selected one or more objects associated with the content of the web page external to the social networking system and characteristics of the user profile comprises:
selecting an object having a characteristic matching a characteristic identified as having an increased importance in the information describing content of a web page external to the social networking system and maintained by the third-party system; and
determining an action associated with the selected object.

20. The method of claim 11, wherein selecting the social context associated with the content of the web page external to the social networking system based on at least one of characteristics of the selected one or more objects associated with the content of the web page external to the social networking system and characteristics of the user profile comprises:
identifying a conversion event associated with the third-party system;
identifying one or more completed conversion events associated with the content of the web page external to the social networking system;
identifying social contexts presented prior to each of the one or more completed conversion events; and
selecting a social context from the identified social contexts based on the identified conversion event.

21. A method comprising:
receiving at a social networking system a request for a social context from a third-party system, the request including information describing content external to the social networking system and maintained by the third-party system;
identifying a user associated with the received request;
accessing information associated with a plurality of objects maintained by the social networking system and describing connections between the objects;
selecting one or more objects associated with the content external to the social networking system based on the information describing the content external to the social networking system included in the request;
retrieving a user profile maintained by the social networking system and associated with the identified user;
selecting a social context associated with the content external to the social networking system based on at least one of characteristics of the selected one or more objects associated with the content external to the social networking system and the user profile; and
providing the social context for presentation in conjunction with the content external to the social networking system.
